(19) United States
(12) Patent Application Publication
(10) Pub. No.: US 2009/0210462 A1
(43) Pub. Date: Aug. 20, 2009

(54) METHODS AND APPARATUS TO CONTROL TRANSITION OF BACKUP DATA

(75) Inventors: Hiroshi ARAKAWA, Sunnyvale, CA (US); Yoshiki Kano, Kanagawa (JP); Akira Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/032,606

(22) Filed: Feb. 15, 2008

(51) Int. Cl. G06F 17/30

(52) U.S. Cl. 707/204; 707/E17.005

(57) ABSTRACT

Disclosed is a system incorporating a management computer, host computers, a backup server and at least one storage system. Backup data generated in the system are stored in various storage system such as disk array, tape library and VTL (virtual tape library) with various methods such as continuous data protection and snapshot, and management information of the backup data is maintained by the management computer. The management computer conducts transition of mode of the backup data by detecting that a condition to perform the transition is satisfied, determining a plan of transition according to predetermined scenario, performing (instructing) the transition based on the plan and updating the management information of the backup data. By keeping the management information up to date, the management computer can provide a unified means to restore necessary data from the backup data even if the transition (moving and/or change) of the backup data has been performed.

### DESCRIPTION OF THE INVENTION

1. Field of the Invention

This present invention generally relates to storage technology and more specifically to management of backup data.

2. Background of the Invention

Recently, a variety of backup data protection methods, such as continuous data protection method (CDP) and copy on write snapshot method have been developed. Storage systems having storage system function and backup software, as well as the corresponding storage devices (e.g. tape library, NAS and VTL) and media (e.g. tape and disk) became available for backup and recovery of data. As known to persons of skill in the art, a backup of production data may be taken and the backup data may be maintained in a storage system using a variety of methods (backup data modes).

Each such mode of backup and data protection has a specific set of characteristics, such as media cost, RTO (Recovery time objective) and RPO (Recovery point objective). The value of the RTO parameter, for example, determines how fast the backup data can be restored from the backup media. The RPO, on the other hand, determines how granular the recovery points are.

As will be clearly understood by persons of skill in the art, the value of a specific set of backup data to the business operation of the user who maintains it may change time to time. Therefore, in order to save costs associated with the used storage media, and to optimize the aforesaid RTO and RPO parameters taking into account the user's actual needs, the backup data mode should be also changed (transited) in response to change of circumstances and the value of the backup data to user's business operation. Moreover, it is desirable to have a unified management environment for managing backup data in order to reduce the cost of backup and recovery data management and the operating costs associated with using various backup methods and systems mentioned above.

However, the conventional industry approaches are deficient in their ability to provide systems for efficient backup data management, which would allow seamless change of backup data mode.

### SUMMARY OF THE INVENTION

The inventive methodology is directed to methods and systems that substantially obviate one or more of the above and other problems associated with conventional techniques for backup data management.

In accordance with one aspect of the inventive methodology, there is provided a computerized storage system including at least one storage system configured to store backup data and a management computer including a central processing unit and a memory. The management computer is operatively coupled to the at least one storage system via an interconnect. This management computer is configured to maintain backup management information associated with the backup data stored in the at least one storage system; detect an occurrence of a condition for transitioning the backup data; develop a transition plan for transitioning the backup data in accordance with a predetermined scenario; initiate a transition based on the developed plan; and update the backup management information based on the transition.

In accordance with another aspect of the inventive methodology, there is provided a method for transitioning backup data stored in at least one backup data storage system. The inventive method involves maintaining backup management information associated with the backup data stored in the at least one storage system; detecting an occurrence of a condition for:transitioning the backup data; developing a transition plan for transitioning the backup data in accordance with a predetermined scenario; performing a transition based on the developed plan; and updating the backup management information based on the transition.

In accordance with a further aspect of the inventive methodology, there is provided a computer readable medium embodying a set of instructions, which, when executed by one or more processors, causes the one or more processors to perform a method for transitioning backup data stored in at least one backup data storage system. The aforesaid method involves maintaining backup management information associated with the backup data stored in at least one storage system; detecting an occurrence of a condition for transitioning the backup data; developing a transition plan for transitioning the backup data in accordance with a predetermined scenario; performing a transition based on the developed plan; and updating the backup management information based on the transition.

In accordance with yet further aspect of the inventive methodology, there is provided a computerized storage system having continuous data protection capability. The inventive system includes a journal volume configured to store a journal; and a snapshot volume configured to store multiple snapshots. The inventive system is further configured to maintain the first interval between snapshots corresponding to an older journal record to be longer than a second interval between snapshots corresponding to a newer journal record.

In accordance with yet further aspect of the inventive methodology, there is provided a method for managing a mode of continuous data protection. The inventive method involves storing a journal; and storing multiple snapshots. In accordance with the inventive method, a first interval between snapshots corresponding to an older journal record is longer than a second interval between snapshots corresponding to a newer journal record.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary configuration of an embodiment of the inventive backup data management system.

FIG. 2 illustrates an exemplary configuration of a management computer.

FIG. 3 illustrates an exemplary logical system configuration of one embodiment of the inventive backup data management system.

FIG. 4 illustrates an exemplary embodiment of a transition process for backup data.

FIG. 5 illustrates an exemplary embodiment of a process for checking a condition for initiating transitioning of backup data to another mode.

FIG. 6 illustrates an exemplary embodiment of term information.

FIG. 7 illustrates another exemplary embodiment of a process for checking a condition for initiating transitioning of backup data to another mode.

FIG. 8 illustrates an exemplary embodiment of service information.

FIG. 9 illustrates yet another exemplary embodiment of a process for checking a condition for initiating transitioning of backup data to another mode.

FIG. 10 illustrates an exemplary embodiment of amount information.

FIG. 11 illustrates an exemplary embodiment of a process for making a plan of transition of backup data according to a scenario provided by a user.

FIGS. 12, 13 and 14 illustrate examples of the above scenario set based on scenario information provided by users by using management computer.

FIG. 15 illustrates an exemplary embodiment of a process of journaling.

FIG. 16 illustrates an exemplary embodiment of consistency group information.

FIG. 17 illustrates an exemplary embodiment of volume information.

FIG. 18 d illustrates an exemplary embodiment of a method of storing journal in journal volume.

FIG. 19 illustrates an exemplary embodiment of contents of metadata.

FIG. 20 illustrates an exemplary embodiment of a snapshot generated using copy on write.

FIG. 21 illustrates an exemplary embodiment of mapping information.

FIG. 22 illustrates an exemplary embodiment of pool information.

FIG. 23 illustrates an exemplary embodiment of an update process with maintaining snapshot.

FIG. 24 illustrates an exemplary embodiment of a process of restoring data using a journal.

FIG. 25 illustrates the use by the host of the recovered point in time (PiT) image of the data.

FIG. 26 illustrates an exemplary embodiment of a transition process associated with first exemplary scenario.

FIG. 27 illustrates an exemplary embodiment of backup data information.

FIG. 28 describes another exemplary embodiment of a transition process associated with first exemplary scenario.

FIG. 29 describes yet another exemplary embodiment of transition process associated with first exemplary scenario.

FIG. 30 describes an exemplary embodiment of transition process associated with the second exemplary scenario.

FIG. 31 illustrates an exemplary change of an interval between snapshots and the corresponding recovery time with the age of the snapshot.

FIG. 32 illustrates exemplary usage of volumes in the storage system.

FIG. 33 illustrates an exemplary embodiment of mapping information.

FIG. 34 illustrates an exemplary embodiment of pool information.

FIG. 35 illustrates an exemplary embodiment of a write process for TPV.

FIG. 36 illustrates an exemplary transition process appearing in the third exemplary scenario.

FIG. 37 illustrates an exemplary embodiment of a restore process for obtaining data from backup data.

FIG. 38 illustrates an exemplary embodiment of a computer platform upon which the inventive system may be implemented.

### DETAILED DESCRIPTION

In the following detailed description, reference will be made to the accompanying drawings, in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

One embodiment of the invention obviates the deficiencies of the prior art and achieves the aforesaid cost reductions and the optimization of the RTO and RPO parameters corresponding to change in conditions and the current value of the backup data. In one embodiment, the inventive system incorporates a management computer, one or more host computers, a backup server and storage systems. Backup data generated in the aforesaid system may be stored in various storage devices such as disk arrays, tape libraries, VTL (virtual tape library) and VDL (virtual disk library having block interface), which may be implemented using various technologies. The management information associated with the backup data is maintained by the management computer. The management computer conducts transition of the backup data mode by first detecting that a condition to perform the transition has occurred, developing a plan of transition according to a predetermined scenario, performing (initiating) the transition based on the developed plan and updating the management information of the backup data in accordance with the performed transition. By keeping the management information up to date, the management computer can provide a unified method for restoring necessary data from the backup data even if the transition (moving and/or change) of the backup data mode has been performed.

An embodiment of the invention provides methods for controlling intervals between snapshots for a CDP system. By applying the inventive system and methods mentioned above, cost reduction and optimization of the RTO and RPO parameters corresponding to change in conditions and the value of the backup data are successfully achieved.

### A. System Configuration

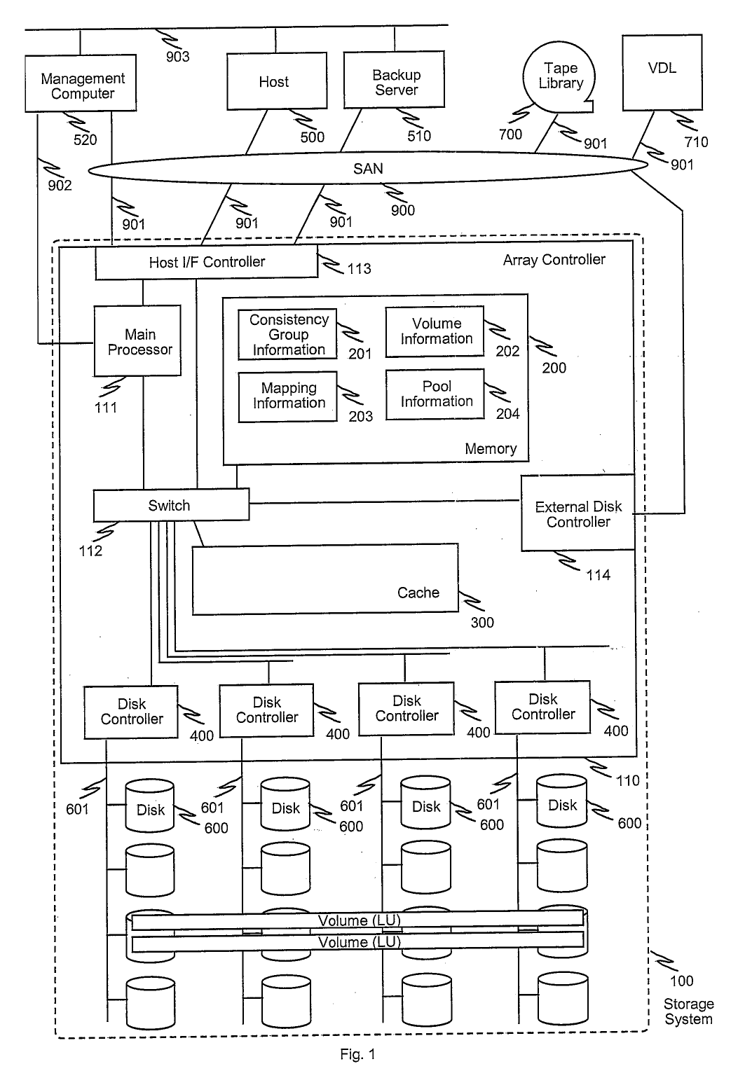

FIG. 1 illustrates an exemplary system configuration of an embodiment of the inventive technique. A storage system 100 in accordance with an embodiment of the inventive concept may incorporate the following components. Specifically, the storage system 100 may include: array controller 110, main processor 111, switch 112, host I/F controller 113, external disk controller 114, memory 200, cache 300, disk controller 400, disk (e.g. HDD) 600 and backend path 601 (e.g. Fibre Channel, SATA, SAS, iSCSl(IP)).

The main processor 111 performs various processes associated with the array controller 110. The main processor 111 and other components use the following information stored in the memory 200: consistency information 201, volume information 202, mapping information 203 and pool Information 204. The main processor 111 performs the aforesaid processes by executing various programs stored in the memory 200.

One or more hosts 500, Backup server 510 and management computer 520 are connected to the host interface 113 via SAN 901 (e.g. Fibre Channel, iSCSI(IP)). VDL (Virtual disk library) 710 is connected to the external disk controller 114 via SAN 901. The host 500, the backup server 510 and the management computer 520 are interconnected via the LAN 903, which may be implemented, for example, as an IP-based network technology.

The management computer 520 is also connected to the array controller 110 via out-of-band Network 902 (e.g. IP). To have capability as computers, Host 500, Backup server 510 and management computer 520 have resources such as processor and memory (not shown in FIG. 1).

Volumes (Logical Units) provided by the storage system 100 are produced from collection of areas in HDDs. They may be protected by storing parity code (i.e. by RAID configuration). One or more hosts 500 can store data in the volume and utilize the data in the volume. In other words, Host 500 writes data to the volume and reads data from the volume.

### B. Configuration of Management Computer

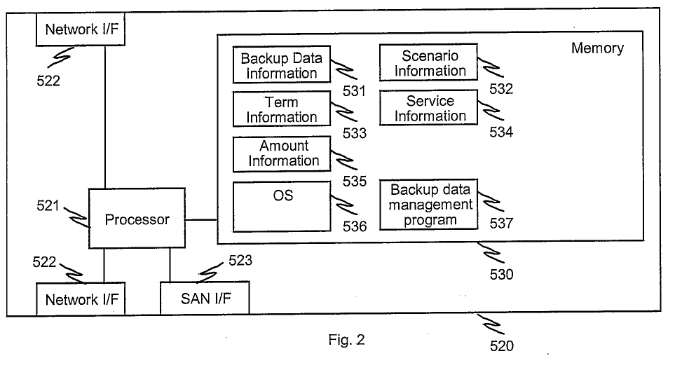

FIG. 2 illustrates an exemplary embodiment of a configuration of a management computer 520. In the shown embodiment, the management computer 520 may include the following components: a processor 521; a network interface 522 (connecting out-of-band Network 902 and LAN 903), a SAN interface 523 (connecting SAN 901) and a memory 530.

Processor 521 performs various processes associated with the management computer 520. The processor 521 and other components use the following information stored in the memory 530: backup data information 531; scenario information 532; term information 533; service information 534 and amount information 535.

The processor 521 performs a backup data management process by executing the OS 536 and the backup data management program 537, which are stored in the Memory 530. The detailed description of the backup data process will be provided below.

### C. Host and Backup Server

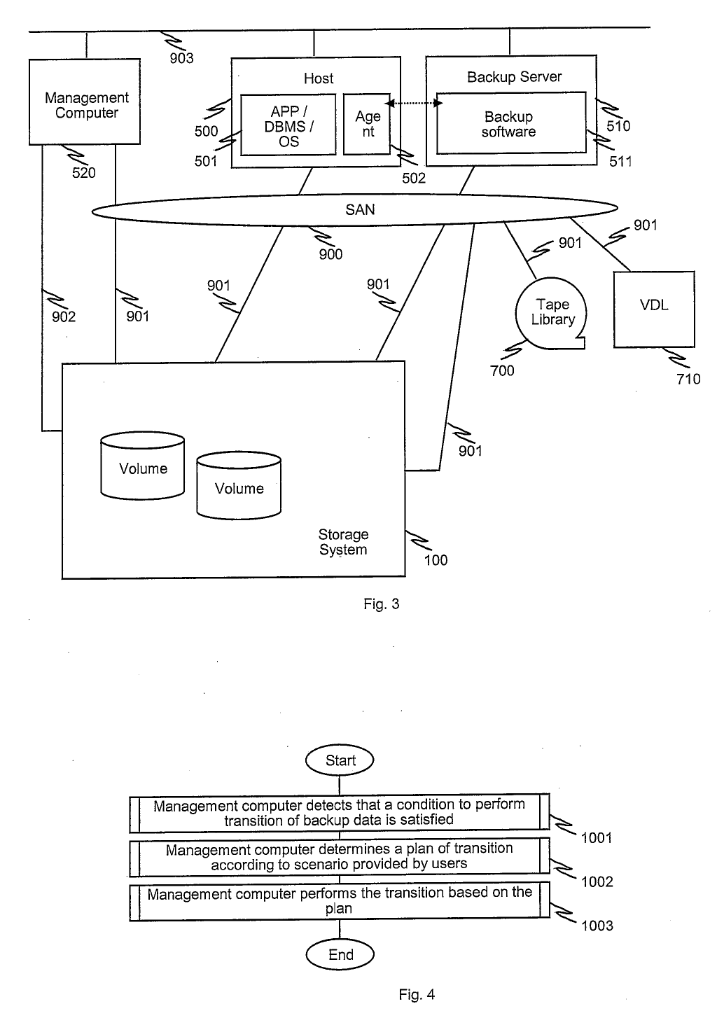

As shown in FIG. 3, the host 500 has the software 501 such as application software, DBMS and OS. Agent software 502 is also located in Host 500 and works in cooperation with Backup software 511 in Backup server 510 via LAN 903. Backup server 510 can get data from volumes in Storage system 100 and store in Tape Library (or VTL) 700 as backup data. Backup server 510 also can restore data in Storage system 100 from the backup data stored in Tape Library (or VTL) 700.

### D. Overview of Transition Process of Backup Data

FIG. 4 illustrates an exemplary embodiment of a transition process -for backup data.

As shown in FIG. 4, at step 1001, the management computer 520 detects an occurrence of a condition that triggers the transition. In various exemplary embodiment of the invention, the aforesaid transition may involve change of location and/or storage mode of the backup data.

At step 1002, the management computer 520 develops a plan of the transition according to a scenario provided by one or more users by means of the management computer 520.

At step 1003, the management computer 520 performs the transition based on the developed plan.

The details of each of the above steps will be provided below.

### E. Condition Check Process for Transition

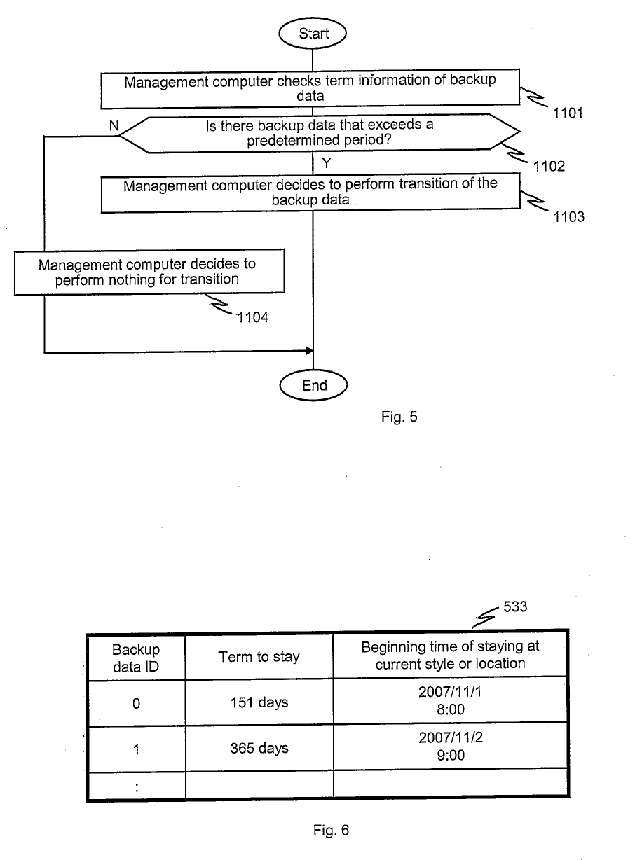

FIG. 5 illustrates an exemplary embodiment of a process for checking whether or not a condition, which triggers transition of the backup data, has occurred.

Specifically, at step 1101, the management computer 520 checks term information 533. FIG. 6 illustrates an exemplary embodiment of the term information 533. This information may incorporate backup data ID, the duration of the current term and the date/time information specifying the beginning of the current state. The duration of the current term indicates a predetermined duration during which the data remains in the current state (e.g. location and/or storage data mode). Users can set the duration by using the management computer 520. The beginning time indicates when the backup data first transitions to the current state. The beginning time is recorded by the management computer 520.

At step 1102, if there is backup data having age exceeding the duration of the current term for the backup data, the process proceeds to step 1103. This check is performed by comparison between the predetermined duration and deference of current time from the beginning time mentioned above. Otherwise, the process proceeds to step 1104.

At step 1103, the management computer 520 determines that the transition of the backup data should be performed.

At step 1104, the management computer 520 determines that no action should be taken. In this case, steps 1002 and 1003 are not executed.

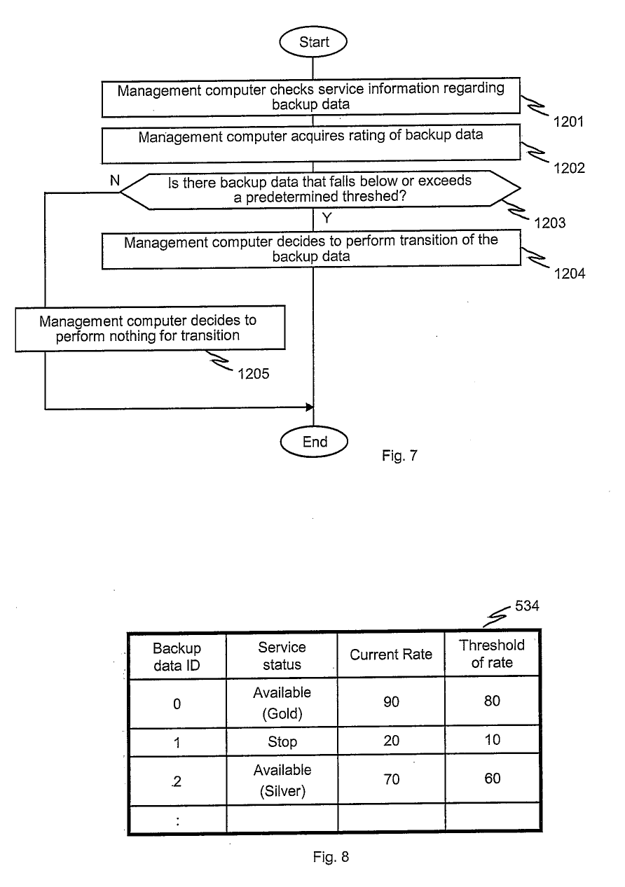

FIG. 7 illustrates another exemplary embodiment of a process for checking a condition triggering the transition of the backup data mode.

At step 1201, the management computer 520 checks service information 534. FIG. 8 illustrates an exemplary embodiment of the service information 534. As shown in FIG. 8, this information may include a backup data ID, a service status of the backup data, a current rate and a predetermined rate threshold. The service status indicates a current status and/or priority of service and/or application using data, which is original data corresponding to the backup data. The service status is gathered and recorded (updated) by the management computer 520. Current rate indicates score based on the service status. In general, running (available) status gets high mark while stop status gets low mark. Moreover, high priority such as ‘Gold’ gets higher mark than low priority. The threshold value indicates a threshold for the backup data to trigger the transition to the next state. A user can set the threshold using the management computer 520.

At step 1202, the management computer 520 acquires the aforesaid rating of the backup data from the service status associated with the backup data.

At step 1203, if there is backup data that falls below or exceeds the threshold, the process proceeds to step 1204. Otherwise, the process proceeds to step 1205.

At step 1204, the management computer 520 determines that a transition of the backup data needs to be performed.

At step 1205, the management computer 520 determines that no action should be taken. In this case, steps 1002 and 1003 are not executed.

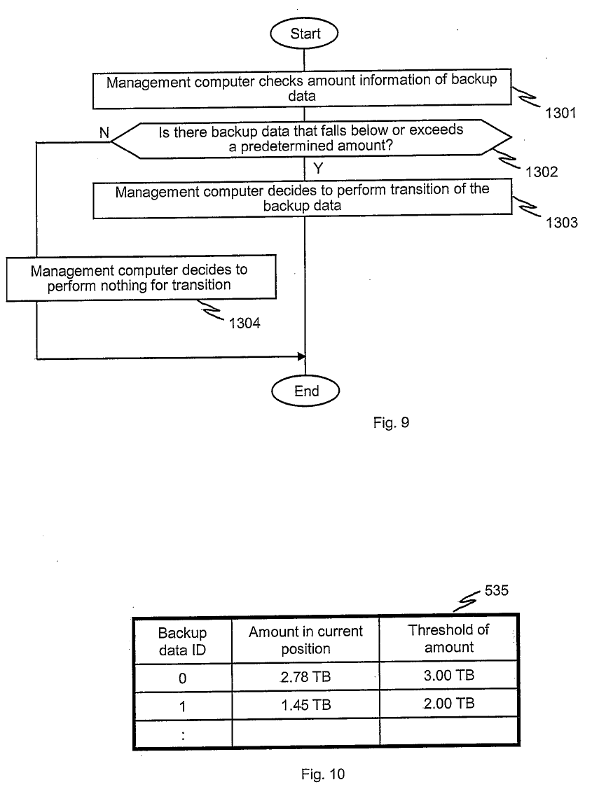

FIG. 9 illustrates yet another exemplary embodiment of a process for checking a condition for triggering a transition of the backup data mode.

At step 1301, the management computer 520 checks the amount information 535. FIG. 10 shows an exemplary embodiment of the amount information 535. In the shown example, this information incorporates the backup data ID, amount of the data in the current storage location and a threshold value corresponding to that amount. The amount of backup data is gathered and recorded (updated) by the management computer 520. Users can set the threshold using the management computer 520.

At step 1302, if the amount of the backup data falls below or exceeds the threshold, the process proceeds to step 1303. Otherwise, the process proceeds to step 1304.

At step 1303, the management computer 520 decides to perform transition of the backup data.

At step 1304, the management computer 520 determines that no action should be performed. In this case, step 1002 and 1003 are not executed.

### F. Transition Planning Process

FIG. 11 illustrates an exemplary embodiment of a process for generating a plan for transitioning of backup data according to a scenario specified by the user.

At step 1401, the management computer 520 references the scenario information 532 and the backup data information 531 with respect to the backup data to be transited.

At step 1402, the management computer 520 determines a manner of the transition based on the Scenario information 532.

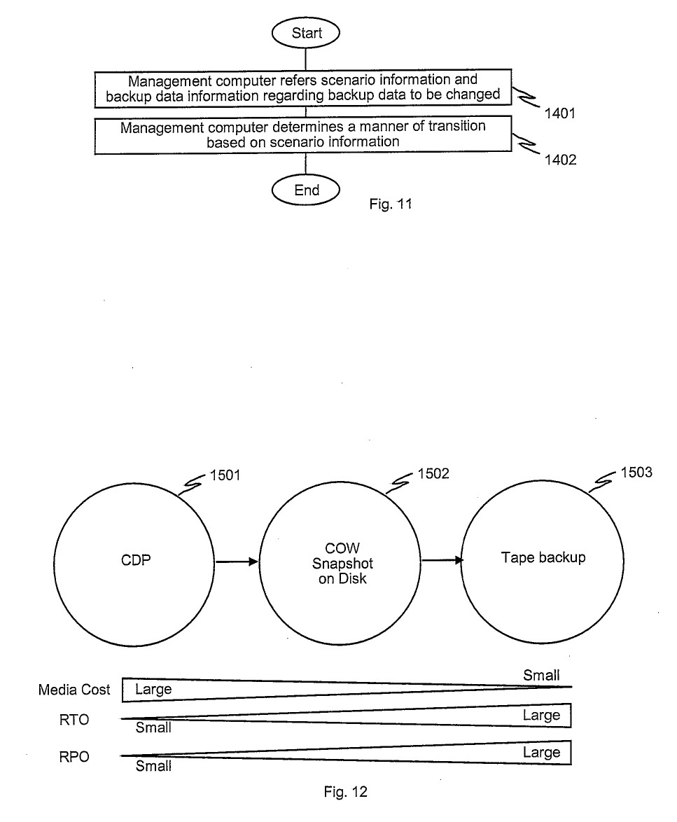

FIGS. 12, 13 and 14 illustrate exemplary embodiments of the above scenario set in the scenario information 532 specified by one or more users using the management computer 520.

FIG. 12 illustrates a first example of a scenario of the backup data mode transition. In this scenario, the mode of backup data changes from continuous data protection (CDP) 1501 to snapshot with copy on write (COW) 1502 and further to tape 1503. The change in the aforesaid mode corresponds to a change in the method, which is used to store the backup data and a change of the media, which is used to store the backup data. The aforesaid transition also changes one or more parameters associated with the backup data, such as media cost, RTO (Recovery time objective) and RPO (Recovery point objective), because each backup data storage mode has different characteristics. According to the above specific scenario (i.e. transitions), the media cost becomes smaller with each of the two transitions because, as described later, CDP uses additional disk capacity in comparison with snapshot and media cost of tape is lower than the cost of disk. Meanwhile, the values of the RTO and RPO parameters become larger because the CDP can achieve the smaller RTO and RPO values as described in detail below.

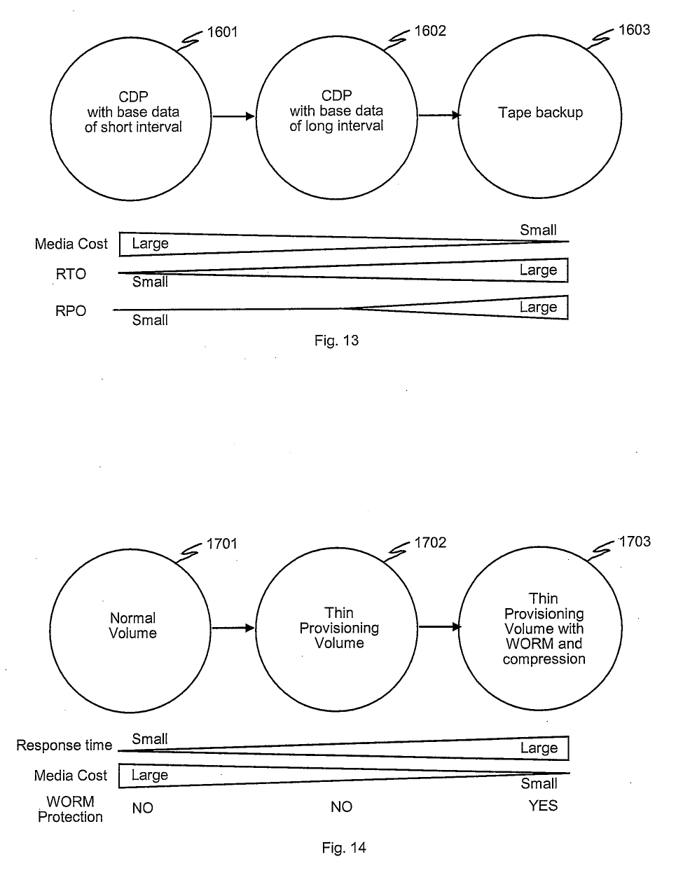

FIG. 13 illustrates a second exemplary scenario of backup data transition. In the scenario, the mode of backup data changes from CDP with base data of short interval 1601 to CDP with base data of long interval 1602, and further to tape 1603. According to this scenario (i.e. transitions), the cost of the used media becomes smaller with each of the above two transitions, because the storage capacity, which is used to store base data is reduced due to the aforesaid transition associated with the CDP snapshot interval increase. Meanwhile, the value of the RTO becomes larger because the average amount of data that needs to be processed during the recovery operation increases with the transition associated with the CDP snapshot interval change, as described in detail below.

FIG. 14 illustrates a third example of a scenario of backup data transition. In this third scenario, the mode of the backup data changes from “in normal volume” 1701 to “in thin provisioning volume” 1702 and further to “in thin provisioning volume with WORM and compression” 1703. According to this scenario (i.e. transitions), the media cost becomes smaller with each transition because the thin provisioning and compression can reduce the storage capacity that is actually used to store the backup data. Meanwhile, the response time for access of the data become larger because accessing data in normal volume does not involve resolving mapping of chunks, which are used in thin provisioning volume, described in detail below. Moreover, this scenario also involves a change of a degree of data protection because applying WORM (i.e. read only) prevents the modification of the backup data.

### G. Explanation of CDP and Snapshot

G.1. Basic process of Journaling

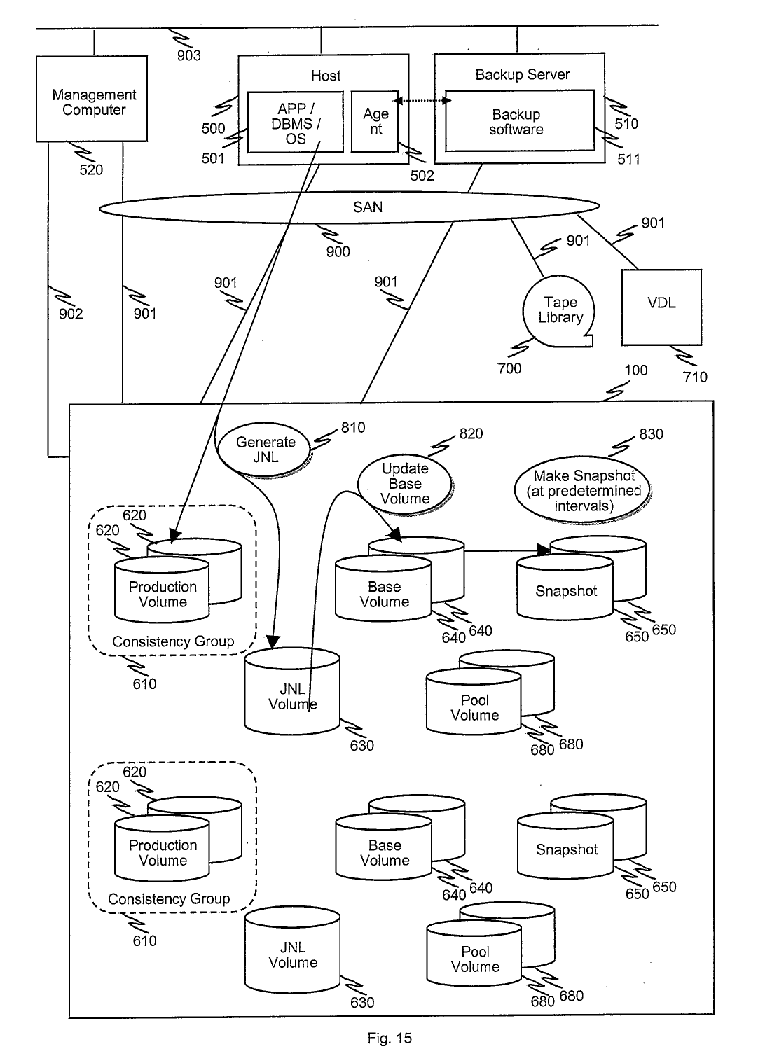

FIG. 15 illustrates a basic process of journaling. As shown in FIG. 15, the software 501 stores data in production volumes 620 provided by the storage system 100. The storage system 100 also incorporates base volumes 640 that constitute a pair together with the production volume 620. The base volume 640 stores a replica data of the paired production volume 620 and receives the same data updates as the production volume 620, as will be described in detail below.

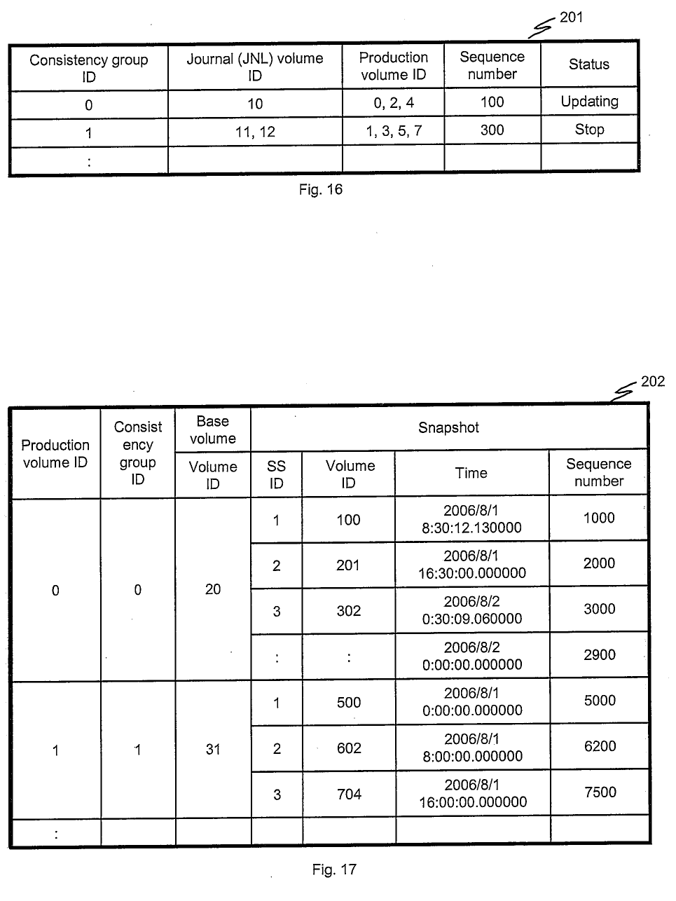

The production volumes 620 constitute a consistency group 610. A generate journal (JNL) function 810 in the storage system 100 obtains update data that is transferred to update the data in the production volumes 620, assigns a sequence number (incremental number) to each journal record per each consistency group 610, and records the update data as a journal record in the journal volumes 630 that are assigned to each consistency group 610. The consistency group information 201 described in FIG. 16 includes information about each consistency group and the relation between the production volume 620 and the journal volume 630. The volume information 202 described in FIG. 17 includes information about the relationship between the production volume 620 and the base volume 640.

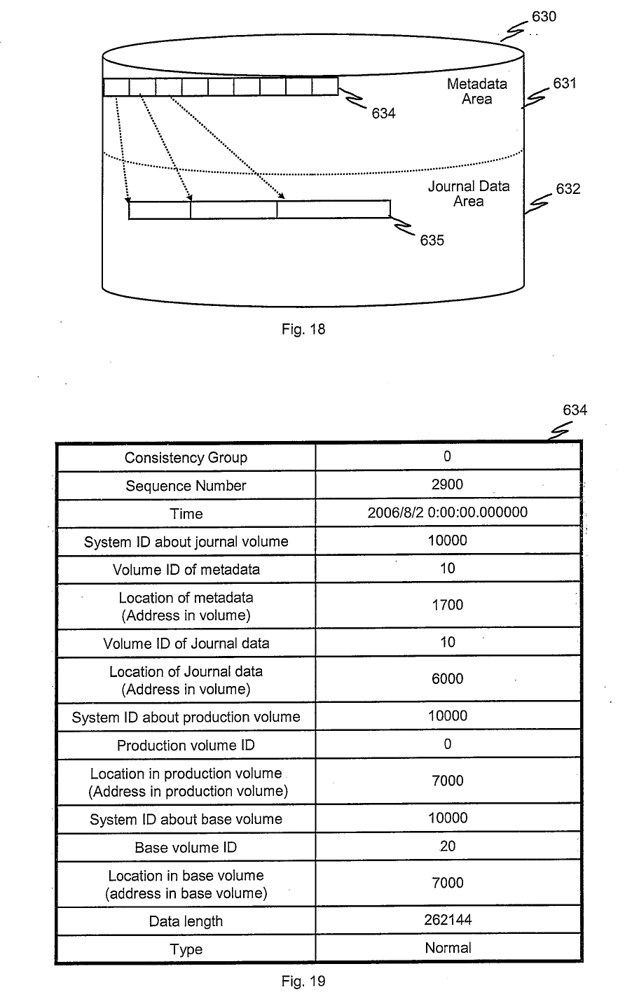

FIG. 18 illustrates an exemplary embodiment of a method for storing journal in the journal volume 630. In the shown embodiment, the journal volume 630 is divided into two areas: a metadata area 631 and a journal data area 632. The generate JNL function 810 stores the update data to the journal data area 632 as journal data 635. After that, the generate JNL function 810 generates information with fixed length (metadata 634) for each journal, records the location of the journal data 635 in the metadata record 634 and stores the metadata record 634 in the metadata area 631. FIG. 19 illustrates an exemplary embodiment of the contents of the metadata 634.

As shown in FIG. 15, the update base volume function 820 in the storage system 100 reads metadata, acquires journal data, and updates the base volume 640 with the journal data according to the sequence number.

Moreover, the make snapshot function 830 in the storage system 100 obtains snapshot of each base volume 640 at predetermined intervals and updates the volume information 202. As described in FIG. 17, the volume information 202 also has information about snapshots. Make snapshot function 830 records the time and sequence number of journal corresponding to snapshot in the volume information 202. The time associated with the metadata 634 and recorded in the volume information 202 are attached by the storage controller 110 as received time or attached by the host 500 as write time. As described in the next section, the pool volumes 680 are used to get and maintain snapshots.

G.2. Basic process of Copy on Write Snapshot

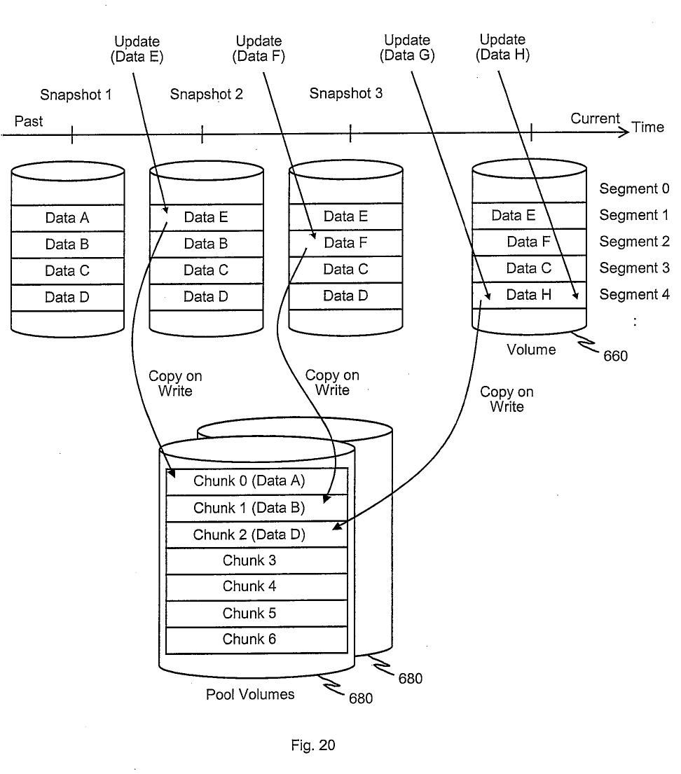

FIG. 20 shows overview of snapshot by copy on write. The storage system 100 has pool volumes 680 and divides Pool volumes 680 into a number of fixed-length areas (i.e. chunks 690). The Storage system 100 takes and provides snapshots for multiple generations (point in time) by copy on write. In this method, at the time of taking snapshot of in storage area is taken, the Storage system 100 does not copy the data. When a write access (update) is performed to the area, the Storage system 100 copies the data before the write (i.e. old data for the access) to chunks in the Pool volume 680. Then the Storage system 100 writes the new data to the target area. By maintaining and managing the old data, the Storage system 100 can provide the snapshot of the original area virtually.

For example, in FIG. 20, an old data A was copied and kept in Chunk 0 in Pool volume 680 when the data E was written. At current time, Data A, Data B and Data D are preserved in the Pool volumes 680, and each snapshot (snapshot 1, 2, or 3) can be reclaimed by using these old data in the Pool volumes 680 and current contents in the volume 660 (most right one in this figure).

To achieve above, the array controller 110 uses the mapping information 203 and Pool information 204.

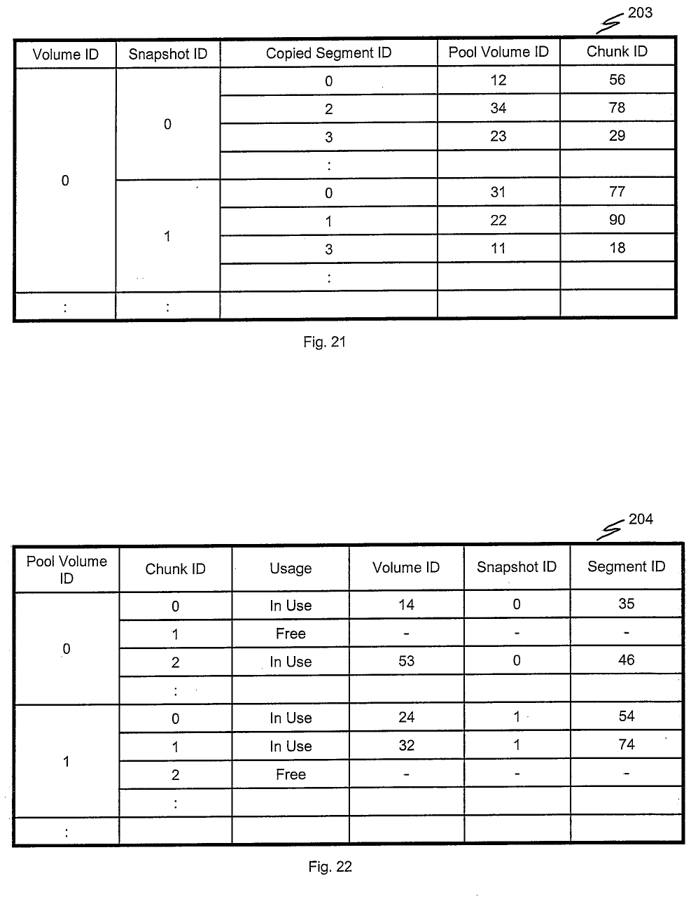

FIG. 21 shows an example of the mapping information 203. This information maintains relation among snapshot, original location (segment) and location of old data in the pool volume 680. In this figure, the original location is specified by the segment ID and the current location of old data is specified by the pool volume ID and chunk ID. In other words, this information maintains mapping between a segment and a chunk. This information can be constructed as list or directory of each element to search a free chunk quickly.

FIG. 22 shows an example of the pool information 204. This information manages a chunk is used or not. By using this information, the array controller 110 is able to find free (unused) chunks in write process described below. This information also can be constructed as list or directory of each element to search a free chunk quickly.

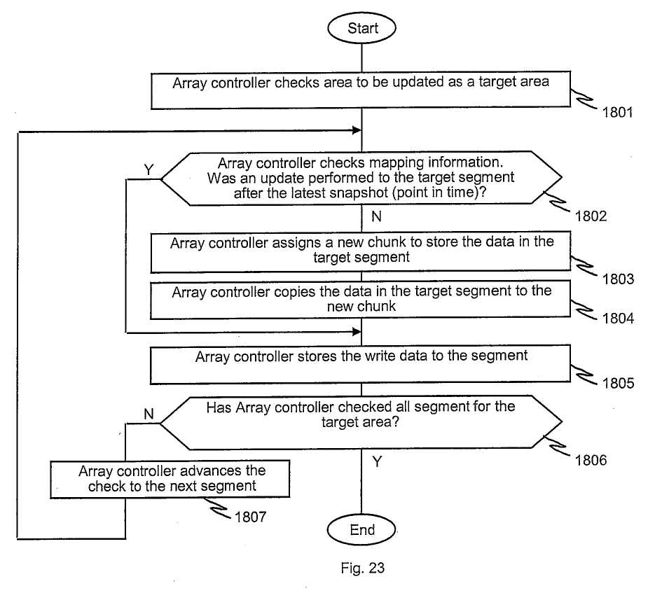

FIG. 23 describes update process with maintaining snapshot.

At step 1801, the array controller 110 checks target volume and target area of write access (update).

At step 1802, the array controller 110 checks the mapping information 203. If other write access occurred in target segment after the latest snapshot (point in time), the process proceeds to 1805. If not, the process proceeds to step 1803.

At step 1803, the array controller 110 assigns a new chunk to store the old data. To do this, the array controller 110 updates the mapping information 203 and the pool information 204.

At step 1804, the array controller 110 copies the data in the target segment to the new chunk.

At step 1805, the array controller 110 stores the new data to the segment.

At step 1806, if the array controller 110 has checked all segments of the target area, the process ends. If not, the array controller 110 advances the check to the next segment (step 1807).

In responding a read access for one snapshot, by referring the Mapping information 203, the array controller 110 finds the chunk having old data that is needed to reclaim the specified snapshot and the segment storing data that is needed to reclaim the specified snapshot. Then -the array controller 110 provides the required data.

### G.3. Basic Process of Restoring Data by Journal

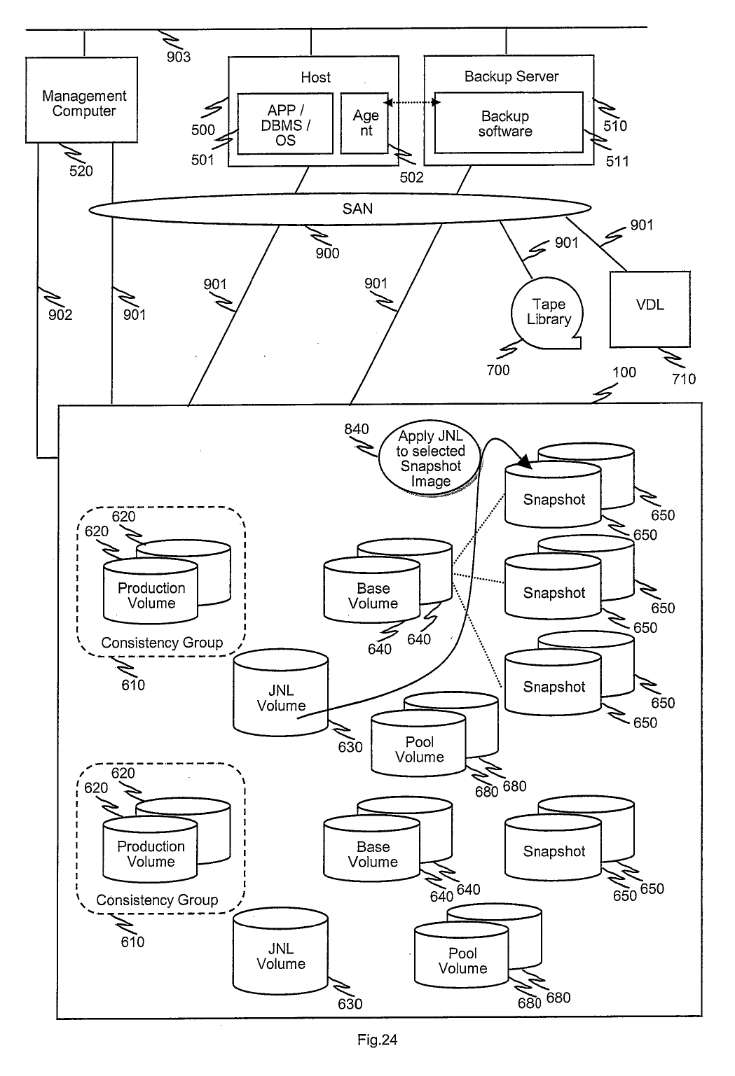

FIG. 24 describes a basic process of restoring data by using journal. First, the management computer 520 instructs restoring data with indicating a point in time to be restored. According to the instruction including indication of the data and the point in time, apply journal function 840 selects a snapshot that has the data before the point in time.

Moreover, the apply journal function 840 applies (writes) journal from the journal corresponding the selected snapshot to the journal corresponding the indicated point in time according to the sequence number in the metadata 634. The nearest snapshot for the target point in time should be selected to make amount of journal to be applied smallest. Apply journal function 840 can recognize the journal to be applied by referring to the volume information 202. After completion of applying the journal, the apply journal function 840 changes status of the snapshot to accessible (read/write access is allowed).

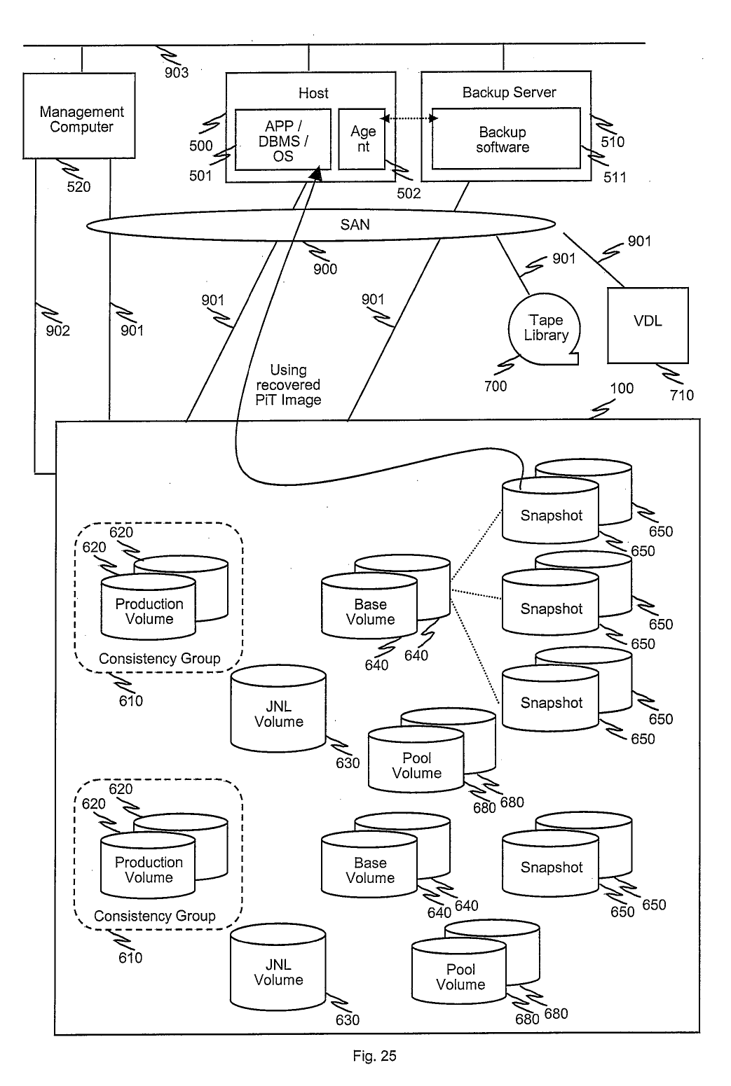

Then, as described in FIG. 25, Host 500 can use the recovered point in time (PiT) image of the data by receiving information from management computer 520 regarding information such as address of the PiT image. Backup server 510 also can use the PiT image as well.

### H. Transition Process

### H.1. First Example of Transition Process

FIG. 26 describes one example of transition process that appears in the first example of scenario mentioned above.

At step 1901, the management computer 520 instructs the array controller 110 to change the mode of the backup data from CDP to snapshot.

At step 1902, the array controller 110 releases journal of the backup data specified by the instruction while the array controller 110 maintains snapshot of the backup data. That is, the array controller 110 updates the volume information 202.

At step 1903, the array controller 110 notifies the management computer 520 of the completion of the change.

At step 1904, the management computer 520 updates the backup data information 531 according to the change.

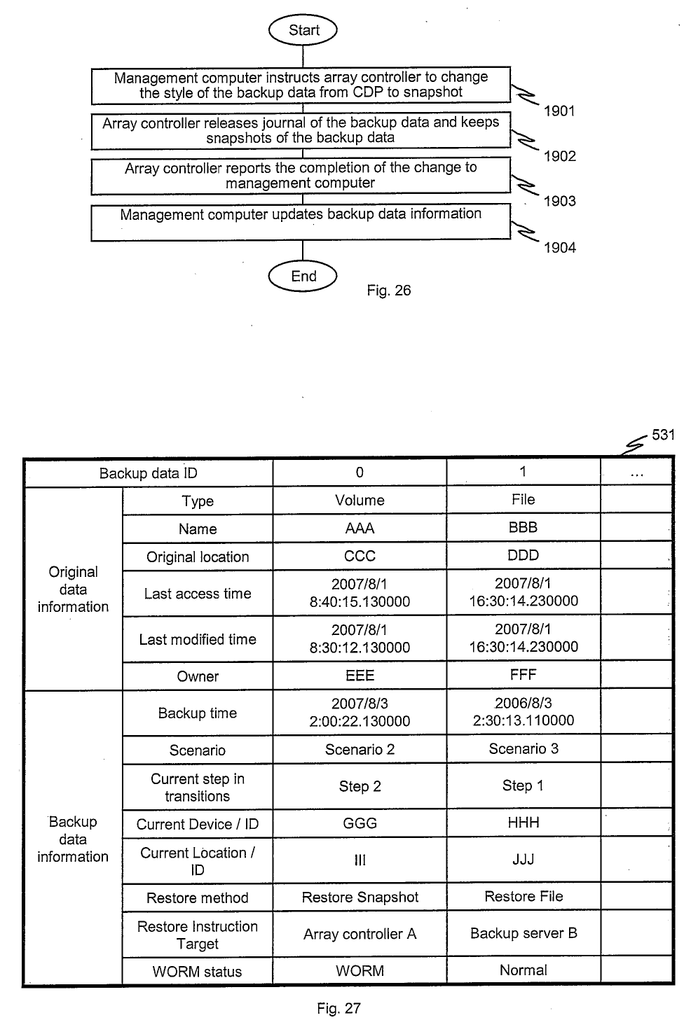

FIG. 27 illustrates an exemplary embodiment of the backup data information 531. This has information about original data of the backup data and information about the backup data. As original data information, this information has type of the data, name of the data, original location of the data, last access time, last modified time, owner of the data and so on. As backup data information, the information has backup time, scenario applied to the backup data, current step in the scenario (i.e. transitions), Current device name or ID of the device storing the backup data, current location address or ID of the backup data, method to restore the data, the devise or computer to be instructed to restore the data and so on. Maintaining the information by tracking backup data enables to restore needed data from backup data that transit among several modes (methods, location and/or device etc.).

FIG. 28 illustrates another exemplary transition process that appears in the first example of scenario mentioned above.

At step 2001, the management computer 520 instructs the backup server 510 to change the mode of the backup data from snapshot to tape backup (or backup using VTL). VTL (Virtual Tape Library) is a disk-based storage system that emulates Tape Library by supporting commands for tape device.

At step 2002, the backup server 510 reads the specified backup data from snapshot specified by the instruction. After that, the backup server 510 writes the backup data to the Tape Library (or VTL) 700.

At step 2003, the backup server 510 informs the management computer 520 of the completion of the backup data moving operation.

At step 2004, the management computer 520 updates the backup data information 531 according to the migration of the backup data.

At step 2005, the management computer 520 instructs the array controller 110 to release the snapshots associated with the backup data.

At step 2006, the array controller 110 releases the snapshots regarding the backup data. That is, the array controller 110 makes the related chunks free (unused) by checking and updating the mapping information 203 and the pool information 204. The array controller 110 also updates the volume information 202.

At step 2007, the array controller 110 notifies the management computer 520 of the completion of the change.

At step 2008, the management computer 520 updates backup data information 531 according to the change.

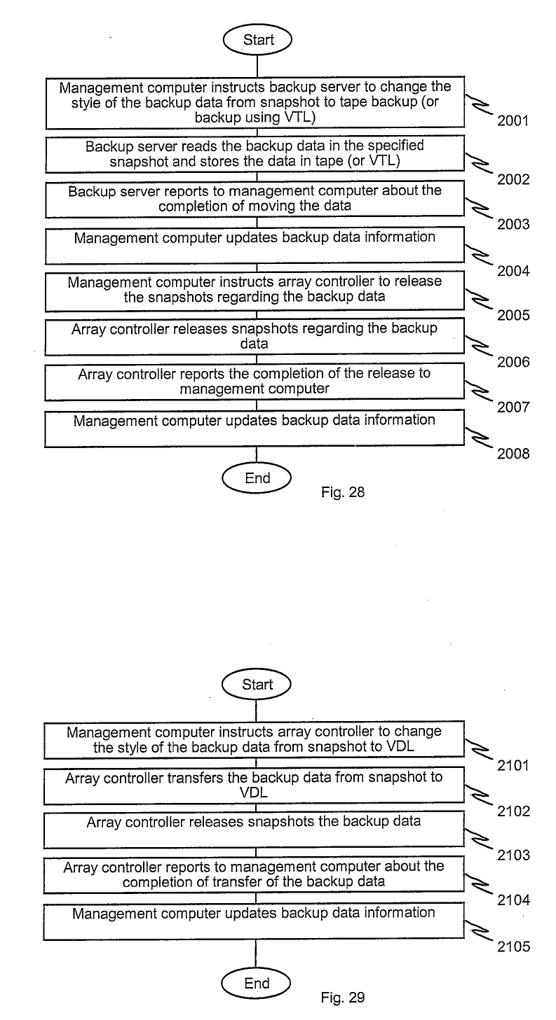

FIG. 29 describes yet another example of transition process that appears in the first example of scenario mentioned above.

At step 2101, the management computer 520 instructs the array controller 110 to change the mode of the backup data from snapshot to VDL. VDL (Virtual Disk Library) is a tape-based storage system that emulates disk by supporting block access commands for disk device.

At step 2102, the array controller 110 transfers the specified backup data from snapshot specified by the instruction to VDL via the external disk controller 114.

At step 2103, the array controller 110 releases the snapshots regarding the backup data. That is, the array controller 110 makes the related chunks free (unused) by checking and updating the mapping information 203 and Pool information 204. The array controller 110 also updates the volume information 202.

At step 2104, the array controller 110 notifies the management computer 520 of the completion of the change.

At step 2105, the management computer 520 updates backup data information 531 according to the change.

### H.2. Second Example of the Transition Process

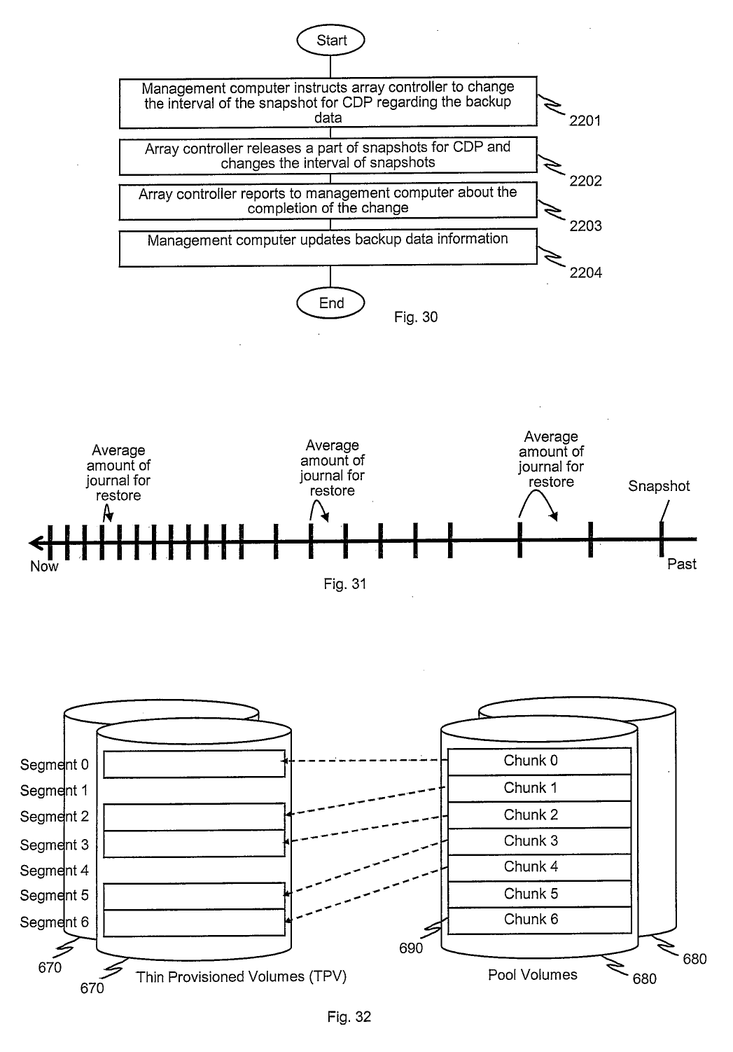

FIG. 30 describes one example of transition process that appears in the second example of scenario mentioned above.

At step 2201, the management computer 520 instructs the array controller 110 to change the interval of the snapshot for CDP regarding the backup data.

At step 2202, the array controller 110 releases snapshots in far past period. That is, the array controller 110 makes the related chunks free (unused) by checking and updating Mapping information 203 and the pool information 204. The array controller 110 also updates the volume information 202.

At step 2203, the array controller 110 notifies the management computer 520 of the completion of the change.

At step 2204, the management computer 520 updates backup data information 531 according to the change.

By the above process, in regard to previously mentioned snapshots used for CDP, interval of the snapshots becomes larger as the snapshot gets old as described in FIG. 31. This means that average time needed to restore older data is longer than the average time for later data because, as described in FIG. 24, the amount of journal to be applied to restore the data is larger than amount for the later data while the capacity (i.e. media cost) for the older data is reduced.

The above process may be performed by the array controller 110 in Storage system 100 based on age of backup data maintained with CDP using the volume information 202. That is, the above control may be performed by the array controller 110 automatically instead of the management computer 520.

### H.3. Third Example of Transition Process

FIG. 32 illustrates exemplary usage of volumes in the storage system 100. The storage system 100 provides thin provisioned volumes (TPV) 670 as storage area for the host 500. The host 500 performs read and write access to store and use data in the TPV 670 via SAN 901. The storage system 100 incorporates pool volumes 680 and divides the pool volumes 680 into a number of fixed-length areas (i.e. chunks 690). The storage system 100 assigns a chunk 690 to a segment of a virtual volume (TPV) on write access. In other words, physical storage area is assigned on demand. In FIG. 32, :a TPV 670 is constituted by multiple segments virtually, and a chunk 690 is allocated from the pool volume 680 and assigned to a segment (i.e. a fixed length area of TPV). For example, the chunk 4 is assigned to Segment 6 in this figure.

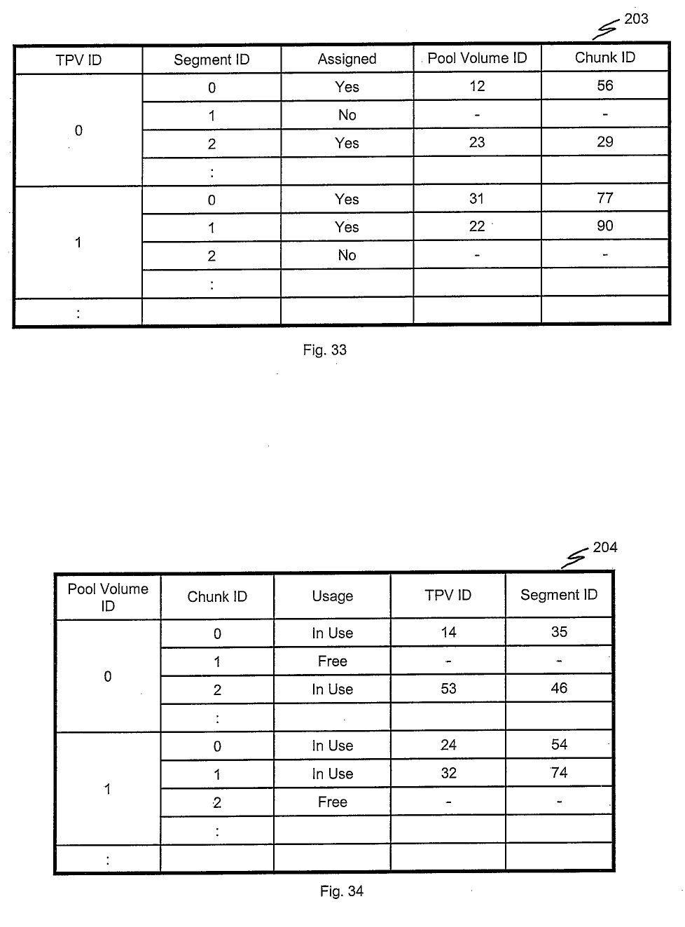

To achieve this, the array controller 110 uses the mapping information 203 and the pool information 204. FIG. 33 is an example of the mapping information 203. This information maintains mapping between chunks and segments of each volume. Status of assignation is ‘No’ if no chunk is assigned to the segment. This information can be constructed as list or directory of each element for faster search.

FIG. 34 illustrates an exemplary embodiment of the pool information 204. This information manages a chunk is used or not. By using this information, the array controller 110 is able to find free (unused) chunks in write process described below. This information also can be constructed as list or directory of each element to search a free chunk quickly.

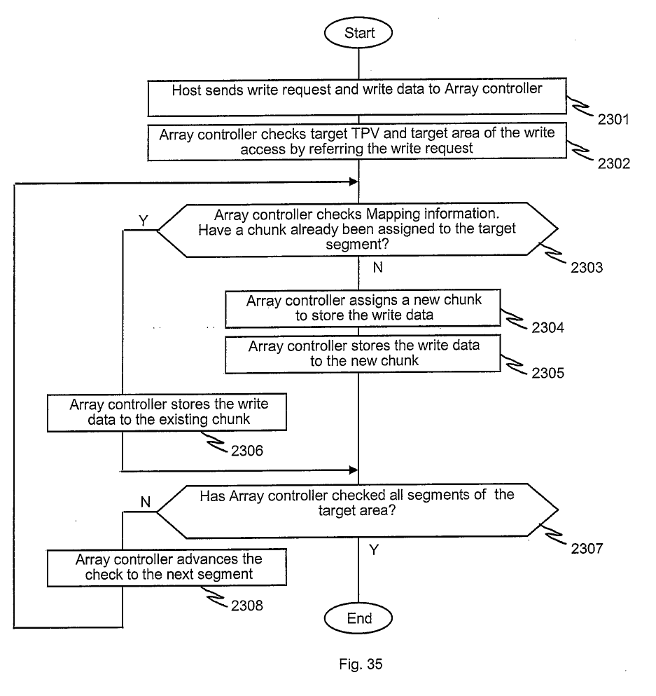

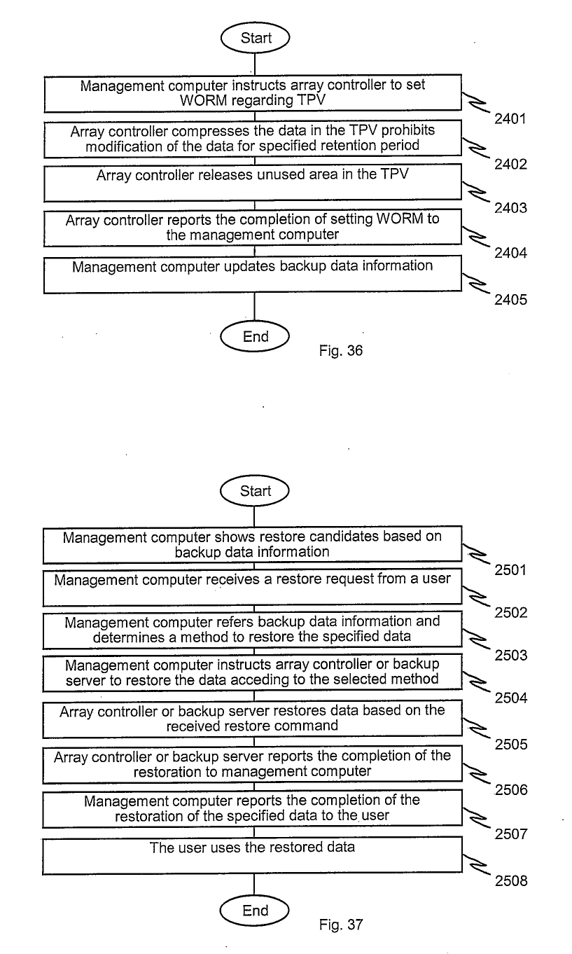

FIG. 35 shows a write process for TPV 670.

At step 2301, the host 500 issues a write request and transfers write data to the array controller 110.

At step 2302, the array controller 110 checks target TPV 670 and target area of the write access by referring the write request.

At step 2303, the array controller 110 checks the mapping information 203 for a segment in the target area. If a chunk has already been assigned to the segment, the process proceeds to step 2306. If not, the process proceeds to step 2304.

At step 2304, the array controller 110 assigns a new chunk to store the write data. To do this, the array controller 110 updates the mapping information 203 and the pool information 204.

At step 2305, the array controller 110 stores the write data to the new chunk.

At step 2306, the array controller 110 stores the write data to the existing chunk.

At step 2307, if the array controller 110 has checked all segments of the target area, the process ends. If not, the array controller 110 advances the check to the next segment (step 2308).

In responding a read request for TPV 670 from the Host 500, by referring the mapping information 203 and the pool information 204, the array controller 110 finds the chunk having data to be read and sends the data to the host 500. If no chunk is assigned to the area specified by the read request, the array controller 110 sends data of zero (0) to the Host 500.

FIG. 36 describes one example of transition process that appears in the third example of scenario mentioned above.

At step 2401, the management computer 520 instructs the array controller 110 to set WORM (write once read many) regarding TPV.

At step 2402, the array controller 110 compresses the data stored in the TPV. It makes unused chunks regarding the TPV. After that, the array controller 110 forbids modification of the data in the TPV for retention period specified by the instruction. That is, setting WORM makes the TPV read-only.

At step 2403, the array controller 110 releases the unused chunk by checking and updating Mapping information 203 and Pool information 204.

At step 2404, the array controller 110 informs the management computer 520 of the completion of setting WORM.

At step 2405, the management computer 520 updates backup data information 531 according to the change.

By the above process, used capacity (media cost) for the data is reduced and protection of the data tightens. After the retention period, the data in the TPV is able to be modified (i.e. removing of WORM).

### I. Restore Process

FIG. 37 illustrates an exemplary embodiment of a restore process for restoring original data from the backup data.

At step 2501, the management computer 520 presents a user with one or more candidate data that can be restored according to the backup data information 531.

At step 2502, the management computer 520 receives a restore request from a user.

At step 2503, the management computer. 520 refers Backup data information 531 and determines a method to restore the data specified by the request.

At step 2504, the management computer 520 instructs the array controller 110 or Backup server 510 to restore the data according to the selected method.

At step 2505, the array controller 110 or the backup server 510 restores data based on the received restore command.

At step 2506, the array controller 110 or the backup server 510 which restores the data notifies the management computer 520 of the completion of restoring the data.

At step 2507, the management computer 520 reports the completion of the restoration of the specified data to the user.

Finally, at step 2508, the user starts to use the restored data.

### J. Exemplary Computer Platform

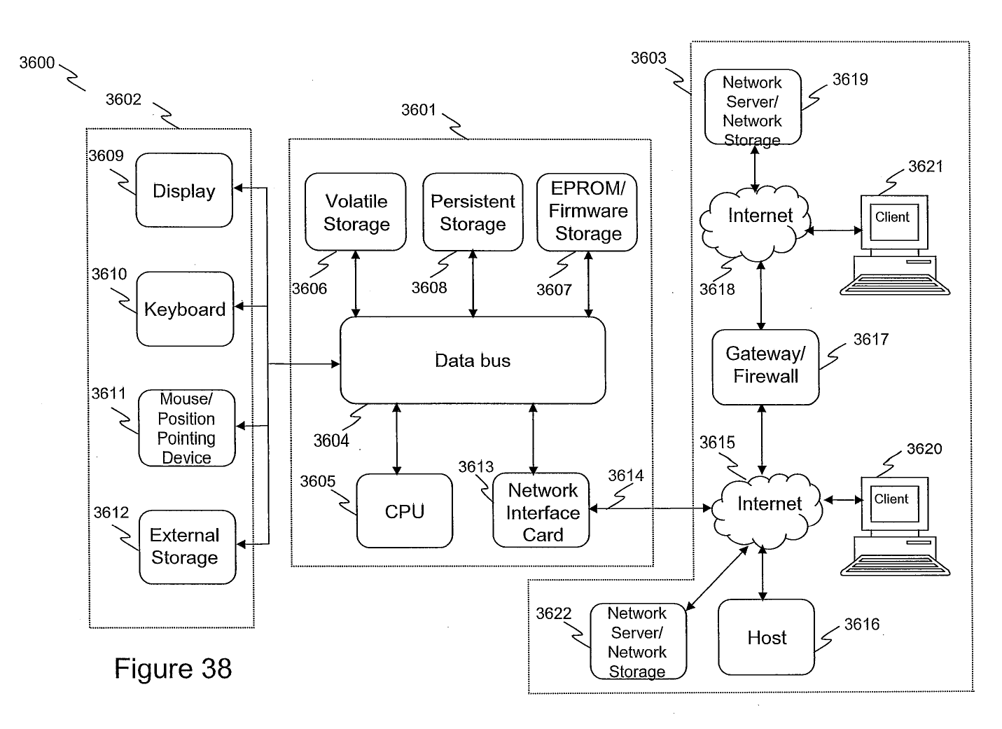

FIG. 38 is a block diagram that illustrates an embodiment of a computer/server system 3600 upon which an embodiment of the inventive methodology may be implemented. The system 3600 includes a computer/server platform 3601, peripheral devices 3602 and network resources 3603.

The computer platform 3601 may include a data bus 3604 or other communication mechanism for communicating information across and among various parts of the computer platform 3601, and a processor 3605 coupled with bus 3601 for processing information and performing other computational and control tasks. Computer platform 3601 also includes a volatile storage 3606, such as a random access memory (RAM) or other dynamic storage device, coupled to bus 3604 for storing various information as well as instructions to be executed by processor 3605. The volatile storage 3606 also may be used for storing temporary variables or other intermediate information during execution of instructions by processor 3605. Computer platform 3601 may further include a read only memory (ROM or EPROM) 3607 or other static storage device coupled to bus 3604 for storing static information and instructions for processor 3605, such as basic input-output system (BIOS), as well as various system configuration parameters. A persistent storage device 3608, such as a magnetic disk, optical disk, or solid-state flash memory device is provided and coupled to bus 3601 for storing information and instructions.

Computer platform 3601 may be coupled via bus 3604 to a display 3609, such as a cathode ray tube (CRT), plasma display, or a liquid crystal display (LCD), for displaying information to a system administrator or user of the computer platform 3601. An input device 3610, including alphanumeric and other keys, is coupled to bus 3601 for communicating information and command selections to processor 3605. Another type of user input device is cursor control device 3611, such as a mouse, a trackball, or cursor direction keys for communicating direction information and command selections to processor 3604 and for controlling cursor movement on display 3609. This input device typically has two degrees of freedom in two axes, a first axis (e.g., x) and a second axis (e.g., y), that allows the device to specify positions in a plane.

An external storage device 3612 may be connected to the computer platform 3601 via bus 3604 to provide an extra or removable storage capacity for the computer platform 3601. In an embodiment of the computer system 3600, the external removable storage device 3612 may be used to facilitate exchange of data with other computer systems.

The invention is related to the use of computer system 3600 for implementing the techniques described herein. In an embodiment, the inventive system may reside on a machine such as computer platform 3601. According to one embodiment of the invention, the techniques described herein are performed by computer system 3600 in response to processor 3605 executing one or more sequences of one or more instructions contained in the volatile memory 3606. Such instructions may be read into volatile memory 3606 from another computer-readable medium, such as persistent storage device 3608. Execution of the sequences of instructions contained in the volatile memory 3606 causes processor 3605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 3605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 3608. Volatile media includes dynamic memory, such as volatile storage 3606. Transmission media includes coaxial cables, copper wire and fiber optics, including the wires that comprise data bus 3604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 3605 for execution. For example, the instructions may initially be carried on a magnetic disk from a remote computer. Alternatively, a remote computer can load the instructions into its dynamic memory and send the instructions over a telephone line using a modem. A modem local to computer system 3600 can receive the data on the telephone line and use an infra-red transmitter to convert the data to an infra-red signal. An infra-red detector can receive the data carried in the infra-red signal and appropriate circuitry can place the data on the data bus 3604. The bus 3604 carries the data to the volatile storage 3606, from which processor 3605 retrieves and executes the instructions. The instructions received by the volatile memory 3606 may optionally be stored on persistent storage device 3608 either before or after execution by processor 3605. The instructions may also be downloaded into the computer platform 3601 via Internet using a variety of network data communication protocols well known in the art.

The computer platform 3601 also includes a communication interface, such as network interface card 3613 coupled to the data bus 3604. Communication interface 3613 provides a two-way data communication coupling to a network link 3614 that is connected to a local network 3615. For example, communication interface 3613 may be an integrated services digital network (ISDN) card or a modem to provide a data communication connection to a corresponding type of telephone line. As another example, communication interface 3613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 3613 sends and receives electrical, electromagnetic or optical signals that carry digital data streams representing various types of information.

Network link 3613 typically provides data communication through one or more networks to other network resources. For example, network link 3614 may provide a connection through local network 3615 to a host computer 3616, or a network storage/server 3617. Additionally or alternatively, the network link 36.13 may connect through gateway/firewall 3617 to the wide-area or global network 3618, such as an Internet. Thus, the computer platform 3601 can access network resources located anywhere on the Internet 3618, such as a remote network storage/server 3619. On the other hand, the computer platform 3601 may also be accessed by clients located anywhere on the local area network 3615 and/or the Internet 3618. The network clients 3620 and 3621 may themselves be implemented based on the computer platform similar to the platform 3601.

Local network 3615 and the Internet 3618 both use electrical, electromagnetic or optical signals that carry digital data streams. The signals through the various networks and the signals on network link 3614 and through communication interface 3613, which carry the digital data to and from computer platform 3601, are exemplary forms of carrier waves transporting the information.

Computer platform 3601 can send messages and receive data, including program code, through the variety of network(s) including Internet 3618 and LAN 3615, network link 3614 and communication interface 3613. In the Internet example, when the system 3601 acts as a network server, it might transmit a requested code or data for an application program running on client(s) 3620 and/or 3621 through Internet 3618, gateway/firewall 3617, local area network 3615 and communication interface 3613. Similarly, it may receive code from other network resources.

The received code may be executed by processor 3605 as it is received, and/or stored in persistent or volatile storage devices 3608 and 3606, respectively, or other non-volatile storage for later execution. In this manner, computer system 3601 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the inventive backup data management system. It is intended that the specification and examples be considered as exemplary only, with a true scope and spirit of the invention being indicated by the following claims..

What is claimed is:

1. A computerized storage system comprising:
a. At least one storage system operable to store backup data;
b. A management computer comprising a central processing unit and a memory, the management computer being operatively coupled to the at least one storage system via an interconnect and being operable to:
i. maintain backup management information associated with the backup data stored in the at least one storage system;
ii. detect an occurrence of a condition for transitioning the backup data;
iii. develop a transition plan for transitioning the backup data in accordance with a predetermined scenario;
iv. initiate a transition based on the developed plan; and
v. update the backup management information based on the transition.

2. The computerized storage system of claim 1, wherein the condition is a predetermined change in a value of the backup data.

3. The computerized storage system of claim 1, further comprising a backup server operatively coupled with the at least one storage system and operable to cause the backup data to be stored in the storage system; and further comprising a host operatively coupled to the backup server, the host being operable to execute an application program and an agent, the agent being operable to communicate with the backup server.

4. The computerized storage system of claim 1, wherein the detecting the occurrence of the condition comprises verifying term information associated with the backup data, wherein the term information comprises a duration of a term during which the backup data remains in a current mode, wherein the verifying the term information comprises checking whether the duration of the term has been exceeded and wherein if the duration of the term has been exceeded, the management computer is operable to initiate the transition of the backup data.

5. The computerized storage system of claim 1, wherein the detecting the occurrence of the condition comprises verifying service information associated with the backup data, wherein the service information comprises a service status associated with the backup data, the service status being indicative of current status or priority of service or application associated with the original data corresponding to the backup data and wherein the service status is being continuously updated by the management computer.

6. The computerized storage system of claim 5, wherein the service information further comprises a current rating of the backup data and a threshold, wherein the verifying the service information comprises checking whether the current rating of the backup data falls below or exceeds the threshold and wherein if the current rating of the backup data falls below or exceeds the threshold, the management computer is operable to initiate the transition of the backup data.

7. The computerized storage system of claim 6, wherein the management computer is operable to enable a user to specify the threshold.

8. The computerized storage system of claim 5,wherein the service information further comprises a current rating of the backup data and a threshold, wherein the verifying the service information comprises checking whether the current rating of the backup data falls below or exceeds the threshold and wherein the current rating of the backup data is determined based on the service status.

9. The computerized storage system of claim 1, wherein the detecting the occurrence of the condition comprises verifying amount information associated with the backup data, the amount information comprising an amount of the backup data in a current location and a threshold value, the amount of the backup data being continuously updated by the management computer, and wherein if the amount of the backup data falls below or exceeds the threshold, the management computer is operable to initiate the transition of the backup data.

10. The computerized storage system of claim 9, wherein the management computer is operable to enable a user to specify the threshold.

11. The computerized storage system of claim 1, wherein the management computer is operable to enable a user to specify scenario information for the scenario for the transition.

12. The computerized storage system of claim 1, wherein the scenario comprises changing a storage mode of the backup data from a continuous data protection mode to a snapshot with copy on write mode and further to tape mode.

13. The computerized storage system of claim 1, wherein the scenario comprises changing a storage mode of the backup data from a continuous data protection mode with short snapshot interval to a continuous data protection mode with long snapshot interval.

14. The computerized storage system of claim 1, wherein the scenario comprises changing a storage mode of the backup data from thin provisioning mode and further to a thin provisioning and a compression mode with write once read many technology.

15. The computerized storage system of claim 1, wherein the scenario comprises changing a storage mode of the backup data from a continuous data protection mode to snapshot mode and wherein during the initiating, the management computer is operable to instruct the storage system to release a journal volume corresponding to the backup data and to maintain snapshots associated with the backup data.

16. The computerized storage system of claim 1, wherein the scenario comprises changing a storage mode of the backup data from snapshot mode to virtual disk library mode and wherein during the initiating, the management computer is operable to instruct the storage system to copy at least one snapshot to a virtual disk library storage system and to release at least portion of snapshots corresponding to the backup data.

17. The computerized storage system of claim 1, wherein the scenario comprises changing a storage mode of the backup data from continuous data protection mode with short snapshot interval to continuous data protection mode with long snapshot interval and wherein during the initiating, the management computer is operable to instruct the storage system to release at least portion of snapshots corresponding to old the backup data so that an interval of the snapshots corresponding to the backup data becomes larger as the snapshots get older.

18. The computerized storage system of claim 1, wherein the scenario comprises changing a storage mode of the backup data from thin provisioning mode to thin provisioning mode with write once read many technology and wherein during the initiating, the management computer is operable to instruct the storage system to compress the backup data stored in a thin provisioning volume and to forbid modification of the backup data stored in the thin provisioning volume.

19. The computerized storage system of claim 1, further comprising restoring at least a portion of the backup data using the backup management information, wherein the restoring is performed according to a restore method, the restore method being determined in accordance with the backup management information.

20. The computerized storage system of claim 1, wherein the management computer is further operable to provide a set of candidate data, wherein the at least a portion of the backup data is selected by a user from the set of candidate data that can be restored based on the backup management information.

21. A method for transitioning backup data stored in at least one backup data storage system, the method comprising:
a. maintaining backup management information associated with the backup data stored in the at least one storage system;
b. detecting an occurrence of a condition for transitioning the backup data;
c. developing a transition plan for transitioning the backup data in accordance with a predetermined scenario;
d. performing a transition based on the developed plan; and
e. updating the backup management information based on the transition.

22. A computer readable medium embodying a set of instructions, the set of instructions, when executed by one or more processors causing the one or more processors to perform a method for transitioning backup data stored in at least one backup data storage system, the method comprising:
a. maintaining backup management information associated with the backup data stored in at least one storage system;
b. detecting an occurrence of a condition for transitioning the backup data;
c. developing a transition plan for transitioning the backup data in accordance with a predetermined scenario;
d. performing a transition based on the developed plan; and
e. updating the backup management information based on the transition.

23. A computerized storage system having continuous data protection capability, the system comprising:
a. a journal volume operable to store a journal; and
b. a snapshot volume operable to store a plurality of snapshots, wherein a first interval between snapshots corresponding to an older journal record is longer than a second interval between snapshots corresponding to a newer journal record.

24. The computerized storage system of claim 23 further comprising a storage controller operable to change the first or the second interval between the snapshots by releasing at least one snapshot, wherein the change of the first or the second interval is performed based on a term of the journal corresponding to a snapshot having a predetermined length of interval.

25. The computerized storage system of claim 23 further comprising a storage controller operable to change the first or the second interval between the snapshots by releasing at least one snapshot, wherein the change of the first or the second interval is performed based on an amount of the journal corresponding to a snapshot having a predetermined length of interval.

26. The computerized storage system of claim 23 further comprising a storage controller operable to change the first or the second interval between the snapshots by releasing releasing at least one snapshot, wherein the change of the first or the second interval is performed according to an instruction received from a management computer based on a recoverable term.

27. A method for managing a mode of continuous data protection, the method comprising:
a. storing a journal; and
b. storing a plurality of snapshots, wherein a first interval between snapshots corresponding to an older journal record is longer than a second interval between snapshots corresponding to a newer journal record.

28. The method of claim 27 further comprising changing the first or the second interval between the snapshots by releasing at least one snapshot, wherein the change of the first or the second interval is performed based on a term of the journal corresponding to a snapshot having a predetermined length of interval.

29. The method of claim 27 further comprising changing the first or the second interval between the snapshots by releasing at least one snapshot, wherein the change of the first or the second interval is performed based on an amount of the journal corresponding to a snapshot having a predetermined length of interval.

30. The method of claim 27 further comprising changing the first or the second interval between the snapshots by releasing at least one snapshot, wherein the change of the first or the second interval is performed according to an instruction received from a management computer based on a recoverable term.
